(19) United States
(12) Patent Application Publication
(10) Pub. No.: US 2010/0002982 A1
(43) Pub. Date: Jan. 7, 2010

(54) Arrangement for monitoring a stressed body and method for the production thereof

(76) Inventors: Ingolf Baumann, Dresden (DE); Thomas Bosselmann, Marloffstein (DE)

Correspondence Address: STAAS & HALSEY LLP, SUITE 700, 1201 NEW YORK AVENUE, N.W., WASHINGTON, DC, 20005, US

(21) Appl. No.: 12/311,946

(22) PCT Filed: Oct. 18, 2007
(86) PCT No.: PCT/EP2007/061141

§ 371 Date: Aug. 14, 2009

(30) Foreign Application Priority Data
Oct. 19, 2006 (DE) 10 2006 049 325.7

(51) Int. Cl. G01L 1/24; G01M 11/08; G02B 6/46; B23P 11/00

(52) U.S. Cl. 385/13; 29/428

(57) ABSTRACT

A system serves to monitor a body exposed to high mechanical or thermal stress. The body has a surface that has at least one groove with two groove lateral walls which are oppositely disposed and adjacent to the surface. An optical waveguide devoid of protective coating, which has a light-guiding core and a casing surrounding it and in which at least one sensor is provided for the optical detection of a measurement variable, is embedded in the groove. The optical waveguide is fixed in place in an area of one of the groove lateral walls, which is adjacent to the surface, by means of at least one caulking.

### CROSS REFERENCE TO RELATED APPLICATIONS

This application is based on and hereby claims priority to PCT Application No. PCT/EP2007/061141 filed on Oct. 18, 2007 and German Application No. 10 2006 049 325.7 filed on Oct. 19, 2008, the contents of which are hereby incorporated by reference.

### BACKGROUND OF THE INVENTION

The invention relates to an arrangement for monitoring a mechanically strongly stressed body and to a method for the production of such an arrangement.

Such an arrangement is disclosed, for example, in DE 102 38 862 A1. The body to be monitored is, in particular, a turbine blade of an electric generator. Depending on the performance class of the generator, very high mechanical and, possibly, also thermal loads can occur on such turbine blades. A strong mechanical load is to be understood here as force effects of up to several 1000 g. Sometimes, the forces even lie further above these values. A strong thermal load is to be understood here as temperatures of up to 800° C. At some points, and, above all, at the surface, however, even temperatures of up to over 1000° C. can occur in the case of turbine blades.

In the monitoring arrangement described in DE 102 38 862 A1, an optical waveguide provided with Bragg grating sensors is either bonded directly onto the surface of the turbine blade or is introduced (in a way not specified in more detail) into a cutout at the surface. The Bragg grating sensors are intended for the measurement of strain, vibration or temperature. The cutouts have relatively large dimensions with opening widths of 0.2 mm to 0.25 mm, and depths of 0.3 mm such that the mechanical strength can be impaired in the event of high loads on the turbine blade. Moreover, bonded optical waveguides can become loosened under extreme loads.

A method for embedding an optical waveguide in a metal body by a solder is disclosed by the technical paper by S. Sandlin et al. “Evaluation of a new method for metal embedding of optical fibers for high temperature sensing purposes”, VTT Symposium 212, BALTICA V, 2001, vol. 2, page 547 et seq. In this case, as well, relatively large cutouts are introduced into the body. Moreover, use is made of a nickel-coated optical waveguide, which is expensive and, moreover, is available only in comparatively short lengths. The embedding method therefore cannot be used particularly well for monitoring a mechanically strongly stressed body such as a turbine blade.

### SUMMARY

It is one possible object to specify an arrangement of the type mentioned at the beginning that remains functional even in the event of high mechanical or thermal loading of the body to be monitored.

The inventors propose an arrangement is one in which the body has a surface that has at least one groove with two groove lateral walls that are situated opposite one another and are respectively adjacent to the surface, an optical waveguide that is without protective coating, has a light guiding core and a cladding surrounding it, and in which there is provided at least one sensor for optically detecting a measured variable, is inserted into the groove and the optical waveguide is fixed in place in the groove by at least one calking in a region, adjacent to the surface, of one of the groove lateral walls.

In the arrangement, use is made of a preferably sensitive optical waveguide (LWL), that is to say one provided with the at least one sensor as an integral component, in the case of which the otherwise always present protective coating or protective cladding has been removed. There is a consequent reduction in the outside diameter down to up to half the value of a protectively coated optical waveguide. As a result, the groove adapted to the outside diameter of the optical waveguide without protective coating that is to be held can have distinctly smaller dimensions than in the case of the known embodiments, in which optical waveguides with protective coating are embedded in the body to be monitored. The, preferably metallic, surface of the body to be monitored is thereby distinctly less affected. Even in the case of very strong mechanical loads of, in particular, up to several 1000 g, the mechanical stability of the entire arrangement thus remains ensured.

Moreover, the mechanical calking of the optical waveguide, which is particularly inserted loosely into the groove, provides a very effective fixing in place. This calking is preferably a protrusion of the material of the body to be monitored. In this case, in particular, the material protrusion extends into the groove space in a fashion perpendicular to the groove longitudinal direction and extending from the relevant groove lateral wall. The material protrusion presses substantially at a point against the optical waveguide lying therebelow and thus holds the latter firmly in the groove. The result of this is a very stable and permanent fixing of the optical waveguide and dimensional stability of the embedding, which above all are maintained even given high mechanical and thermal loads.

By contrast, given such extreme loads of the known embodiments, material connections can be loosened because of the different properties of the materials involved. The materials used in the related art have both a very strongly mutually deviating thermal expansion behavior, and also an inadequate long-time stability. Thus, for example, the connection formed by an epoxy adhesive between the optical waveguide and the body to be monitored can loosen with time. Moreover, the connection between the optical waveguide glass cladding and the outer plastic protective coating can be lost, and so the inner optical waveguide glass part formed by the fiber core and the fiber cladding moves inside the outer protective coating. This can result in measuring errors.

These difficulties cannot occur in principle in the case of the mechanical calking of the optical waveguide without protective coating. Preferably only two different materials are involved, specifically the material of the body to be monitored and that of the optical waveguide without protective coating, that is to say that of the inner optical waveguide portion. Punctiform calkings that include, in particular, the material of the body to be monitored, serve to fix the optical waveguide. The monitoring arrangement advantageously manages without separate materials for an adhesive or soldered connection, or for a protective coating of the optical waveguide. Thermal loads of, in particular, up to approximately 800° C., and strong mechanical stresses therefore have no negative effect on the mechanical stability of the entire arrangement.

Overall, the monitoring arrangement therefore has a distinctly improved functional capability and functional reliability.

One advantageous variant is one in which the groove has an opening width that is larger by at most 5% to 10%, in particular by 1.5% to 8%, than an outside diameter of the optical waveguide. This close adaptation of the groove to the small outside diameter of the optical waveguide without protective coating results in a particularly slight impairment of the surface of the body to be monitored.

Furthermore, the groove can preferably have a V-shaped or U-shaped cross section. A V-groove offers an advantageous 2-point support. In the case of a U-groove, the U-arc radius is preferably approximately adapted to the LWL outside radius of the optical waveguide without protective coating. There is a very good guidance, with reduced loading, and bearing of the optical waveguide without protective coating, as a result. If appropriate, the U-arc radius is slightly, for example by 2.5% to 5%, larger than the LWL outside radius, in order to facilitate the insertion of the optical waveguide.

In accordance with another advantageous variant, the groove has no calking in the groove lateral walls in the region of a measuring point at which the sensor is arranged inside the optical waveguide inserted into the groove. This prevents the calking from influencing the sensor, designed preferably as a Bragg grating sensor, and the occurrence of defective measurement results.

In contrast, it is provided in the case of a further preferred refinement that the groove has at least one calking in the groove lateral walls immediately before or immediately after a measuring point at which the sensor is arranged inside the optical waveguide inserted into the groove. In principle, at least one calking can be provided in each case at both ends of the sensor, that is to say immediately before and immediately after the measuring point. The placing of the calking onto the boundary of the measuring point enables a particularly exact fixing of the sensor in place such that measuring errors, for example owing to slight local displacements of the measuring point, are excluded.

Furthermore, a plurality of calkings are advantageously provided that are arranged separated from one another in a longitudinal direction of the groove at a spacing of a few cm, in particular of from 2 to 3 cm. This results in a particularly effective and permanent fixing in place of the inserted optical waveguide, which also withstands very large mechanical loads.

Moreover, it is likewise advantageous with regard to fixing the optical waveguide as effectively as possible when a plurality of calkings are provided that are arranged on both groove lateral walls. Fixing at both ends by the calkings is particularly reliable. It is then advantageously possible, in addition, for one of the calkings provided in one groove lateral wall to be situated exactly opposite one of the calkings provided in the other groove lateral wall. The degree of the protrusion of the individual calkings, and thus the pressure exerted on the optical waveguide at the respective point can thereby be reduced. Moreover, it is possible to produce more easily a smaller protrusion in the usually very hard surface of the body to be monitored. The requisite fixing of the optical waveguide is then, however, nevertheless provided at both groove lateral walls because of the protrusions situated opposite one another. Furthermore, the calkings that are provided on both groove lateral walls can also be arranged in principle in a fashion offset from one another.

A further potential object relates to specifying a method with the aid of which it is possible to produce a functional arrangement even in the event of high mechanical or thermal loading of the body to be monitored.

The inventors propose a production method in which a groove with two groove lateral walls that are situated opposite one another is introduced into a surface of a body to be monitored, in which an outer protective coating is removed from an optical waveguide provided with at least one sensor for optically detecting a measured variable, such that a light guiding core and a cladding surrounding it are left over, in which the optical waveguide without protective coating is inserted loosely into the groove and in which at least one of the groove lateral walls is calked in a region adjacent to the surface such that the optical waveguide inserted into the groove is fixed in place.

A monitoring arrangement proposed by the inventors can be produced particularly easily with the aid of the method. In order to remove the protective coating that usually is formed of a plastic, for example of acrylate, the protectively coated optical waveguide is laid in a solvent, for example in an acetone solution. The acetone acts on the plastic of the protective cladding without attacking the inner optical waveguide portion (glass core and glass cladding) formed, preferably, of glass. The plastic protective coating thus treated can then be stripped off without a problem from the inner optical waveguide portion.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary embodiment of a monitoring arrangement with an optical waveguide without protective coating that is inserted into a groove on the surface of a body and secured by calkings,

FIG. 2 shows a design of a protectively coated optical waveguide,

FIG. 3 shows an exemplary embodiment of a monitoring arrangement with a V-shaped groove for holding an optical waveguide, in a partially assembled state,

FIG. 4 shows an exemplary embodiment of a monitoring arrangement with a U-shaped groove for holding an optical waveguide in a partially assembled state,

FIG. 5 shows the monitoring arrangement in accordance with FIG. 3 with calkings on the groove lateral walls above the optical waveguide inserted into the groove, and

FIG. 6 shows the monitoring arrangement in accordance with FIG. 4 with calkings on the groove lateral walls above the optical waveguide inserted into the groove.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

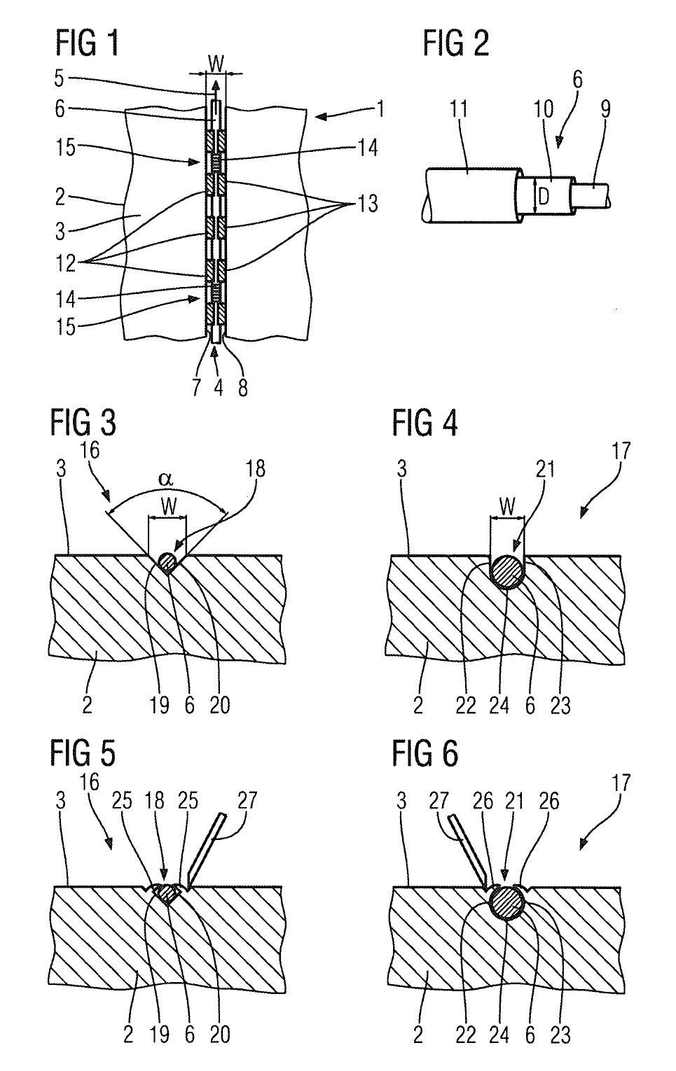

Mutually corresponding parts are provided in FIGS. 1 to 6 with the same reference symbols.

FIG. 1 shows an exemplary embodiment of a monitoring arrangement 1. It serves the purpose of monitoring a mechanically and thermally strongly stressed body that is designed in the exemplary embodiment as a turbine blade 2. Provided on one surface 3 of the turbine blade 2 is a groove 4 with a groove longitudinal direction 5 and an upper opening width W. The groove 4 has two groove lateral walls 7 and 8 that extend away from the surface 3 in the direction of a groove bottom which is not visible in FIG. 1. Apart from the groove 4 shown in exemplary fashion, further similar grooves can also be provided on the surface 3. An optical waveguide 6 is loosely inserted into the groove 4. The optical waveguide 6 is without protective coating.

FIG. 2 shows the optical waveguide 6 still before it has been embedded in the turbine blade 2. It has a light guiding core 9, a cladding 10 surrounding the core 9, and an outer—if appropriate multilayer—protective coating 11. The inner optical waveguide portion is formed by the core 9 and the cladding 10. They are formed in the exemplary embodiment of glass. What is involved is a glass fiber optical waveguide. The cladding 10 has a lower optical refractive index than the core 9, and so the light propagating in the core 9 is totally reflected at the cladding 10 and is thus guided in the core 9.

The inner optical waveguide portion has an outside diameter D that is 125 μm in the exemplary embodiment. With the outer protective coating 11, formed of plastic, for example, there is a total outside diameter of approximately 250 μm.

The outer protective coating 11 is removed before the embedding in the turbine blade 2, in order to reduce the external dimensions to the outside diameter D. The dimensions of the groove 4 such as, for example, its opening width W and also a groove depth that is not depicted in any more detail, are adapted to the outside diameter D. In the exemplary embodiment of FIG. 1, the opening width W is larger by approximately 2 μm to 5 μm than the outside diameter D.

The optical waveguide 6 lying in the groove 4 is fixed in place on the two groove lateral walls 7 and 8, respectively, by a plurality of calkings 12 and 13. The calkings 13 are protrusions of the material of the turbine blade 2 that extend into the region of the groove 4 perpendicular to the groove longitudinal direction 5 above the optical waveguide 6. In each case one of the calkings 12 of the groove lateral wall 7 lies opposite one of the calkings 13 of the groove lateral wall 8. The points, at which a pair of the points are respectively provided with calkings 12 and 13 at both ends, are spaced apart from one another by approximately 2 cm to 3 cm in the groove longitudinal direction 5.

The optical waveguide 6 has a plurality of Bragg grating sensors 14 that are respectively intended for detecting a measured variable present at an associated measuring point 15 of the turbine blade 2 to be monitored. The measured variables can, for example, be an extension, a mechanical vibration or a temperature. Pairs with calkings 12 and 13 at both ends are provided immediately adjacent to the measuring points 15 and respectively on the two longitudinal sides of the measuring points 15. The optical waveguide 4 is thereby particularly effectively fixed in its position in the regions at which it has Bragg grating sensors 14. The individual Bragg grating sensors 14, and thus the measuring points 15, can be arranged in principle at any desired spacings from one another. The respective position is determined by the measuring task.

Further exemplary embodiments of monitoring arrangements 16 and 17, respectively, for the turbine blade 2 are respectively shown in cross-sectional illustrations in FIGS. 3 and 5, and 4 and 6, respectively.

The monitoring arrangement 16 in accordance with FIGS. 3 and 5 has a V-groove 18 with groove lateral walls 19 and 20. The embedded optical waveguide 6 lies on two contact lines that appear in the cross-sectional illustration in accordance with FIGS. 3 and 5 as two contact points and run substantially in the groove longitudinal direction 5 on the two groove lateral walls 19 and 20. An opening angle α formed by the two groove lateral walls 19 and 20 is selected such that, on the one hand, effective support of the optical waveguide 6 is ensured and, on the other hand, the opening width W is small. The opening angle α is between 45° and 120°, preferably being 90°±10°.

The monitoring arrangement 17 in accordance with FIGS. 4 and 6 has a U-groove 21 with groove lateral walls 22 and 23, and a round U-bottom 24 on which the optical waveguide 6 rests. The radius of curvature of the monitoring arrangement 17 is slightly larger than that of the outside circumference of the optical waveguide 6.

Like the groove 4 of the monitoring arrangement 1 in accordance with FIG. 1, the V-groove 18 and the U-groove 21 are also adapted in their respective groove dimensions to the optical waveguide 6 without protective coating that is to be held. In each case, only a slight play of the order of magnitude of up to 5 μm is provided in order to be able to insert the optical waveguide 6 easily.

After the optical waveguide 6 is loosely inserted into the respective V-groove or U-groove 18 or 21, respectively, (see the partly assembled states shown in FIGS. 3 and 4), calkings 25 and 26, respectively, are produced in the upper region, that is to say in the region adjacent to the surface 3, of the groove lateral walls 19 and 20 and 22 and 23, respectively, by a gouge type calking tool 27. The material of the turbine blade 2 in this case lies partially over the optical waveguide 6 and thus holds the latter securely in the V-groove or U-groove 18 or 19, respectively (see illustrations in accordance with FIGS. 5 and 6).

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-9. (canceled)

10. A system, comprising:
a mechanically or thermally strongly stressed body including a surface having at least one groove defined therein with two groove lateral walls situated opposite one another and adjacent to the surface, the surface including at least one projection projecting from at least one of the two groove lateral walls and partially formed over the groove; and
an optical waveguide fixed in the groove by the at least one projection, the optical waveguide having a light guiding core and a cladding surrounding the light guiding core, and including at least one sensor to optically detect a measured variable at a measuring point of the body.

11. The system as claimed in claim 10, wherein the optical waveguide is without a protective coating.

12. The system as claimed in claim 10, wherein the groove has an opening width that is larger by 5% to 10% than an outside diameter of the optical waveguide.

13. The system as claimed in claim 10, wherein the groove has a V-shaped or U-shaped cross section.

14. The system as claimed in claim 10, wherein the at least one projection is not formed at the measuring point at which the sensor arranged inside the optical waveguide is positioned in the groove.

15. The system as claimed in claim 10, wherein the at least one projection is formed in at least one of the groove lateral walls in the groove immediately before or immediately after the measuring point at which the sensor arranged inside the optical waveguide is positioned in the groove.

16. The system as claimed in claim 10, wherein a plurality of projections are separated from one another in a longitudinal direction of the groove.

17. The system as claimed in claim 16, wherein the projections are separated from one another at a spacing of between about 2 and 3 centimeters.

18. The system as claimed in claim 10, wherein the at least one projection includes a projection projecting from each of the groove lateral walls.

19. The system as claimed in claim 18, wherein one of the projections projecting from one groove lateral wall is situated opposite another of the projections projecting from the other groove lateral wall.

20. A method of producing a mechanically or thermally strongly stressed body measuring system, comprising:
introducing a groove having two groove lateral walls into a surface of the body to be monitored;
loosely inserting an optical waveguide into the groove, the optical waveguide including at least one sensor to optically detect a measured variable at a measuring point of the body; and
forming at least one projection from at least one of the groove lateral walls to extend partially over the optical waveguide inserted into the groove to fix the optical waveguide within the groove.

21. The method as claimed in claim 20, wherein an outer protective covering is removed from the optical waveguide to expose a light guiding core and a cladding surrounding the light guiding core of the optical waveguide before the optical waveguide is inserted into the groove.
